(19) United States
(12) Patent Application Publication
(10) Pub. No.: US 2015/0058681 A1
(43) Pub. Date: Feb. 26, 2015

(54) MONITORING, DETECTION AND ANALYSIS OF DATA FROM DIFFERENT SERVICES

(71) Applicant: Microsoft Corporation, Redmond, WA (US)

(72) Inventors: Sreekanth Lingannapeta, Redmond, WA (US); Arshish Kapadia, Issaquah, WA (US); Richard Fillman, Bellevue, WA (US); Ryan Yandle, Seattle, WA (US); Gheorghita Irimescu, Sammamish, WA (US); Soroush Salehian, Redmond, WA (US); Jean Donati, Kirkland, WA (US)

(73) Assignee: Microsoft Corporation, Redmond, WA (US)

(21) Appl. No.: 14/010,229

(22) Filed: Aug. 26, 2013

(51) Int. Cl. G06F 11/34

(52) U.S. Cl. CPC G06F 11/3495
USPC 714/47.3

(57) ABSTRACT

A fault monitoring, detection and analysis system obtains data (e.g. online service facts) from different data sources. Many times the data obtained from the different data sources is in different formats. The data is classified (e.g. into error, performance and usage events/facts) based on user configured multi-dimensional (time, topology, functional area) filter criteria. The data from the different data sources is normalized into a standard format and stored. The data may also be grouped and duplicates may be removed before and/or after the normalized data is stored. Analysis is performed on the normalized data. For example, the analysis may monitor for expected events, unexpected events, detect abnormal behavior of the system, and the like. Different users may submit different jobs to the system to obtain data from the data store. A reporting service exposes one or more views of the data and/or the analysis of the data.

### BACKGROUND

Many online services produce a large amount of telemetry data. For example, online services may produce terabytes of telemetry data per day. Different programs may be developed to look for data from an online service to look for different situations. For example, a program may be created to notify a system administrator when a failure occurs in an online service. Monitoring and analyzing the telemetry data can be very difficult.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A fault monitoring, detection and analysis system obtains data (e.g., online service facts) from different data sources. Many times the data obtained from the different data sources is in different formats. The data is classified (e.g. into error, performance and usage events/facts) based on user configured multi-dimensional (time, topology, functional area) filter criteria and/or predefined criteria. The data from the different data sources is normalized into a standard format and stored (i.e., within a data store) together. The data may also be grouped and duplicates may be removed before and/or after the normalized data is stored. Analysis is performed on the normalized data. For example, the analysis may monitor for expected events, unexpected events, detect abnormal behavior of the system, and the like. The analysis may be performed automatically and/or manually. Different users may submit different jobs to the system to obtain data from the data store. A reporting service exposes one or more views of the data and/or the analysis of the data.

### BRIEF DESCRIPTION OF THE DRAWINGS

FIG. 1 shows an overview of a system for monitoring, detection and analysis of data from different services;

FIG. 2 illustrates a system for monitoring, detection and analysis of data from different services in different formats;

FIG. 3 shows a process for accessing, obtaining, and analyzing data from different sources;

FIG. 4 shows a process for processing data that is obtained from different sources in different formats;

FIG. 5 illustrates an exemplary online system for gathering, and analyzing data obtained from different data sources; and

FIGS. 6, 7A, 7B and 8 and the associated descriptions provide a discussion of a variety of operating environments in which embodiments of the invention may be practiced.

### DETAILED DESCRIPTION

Referring now to the drawings, in which like numerals represent like elements, various embodiment will be described.

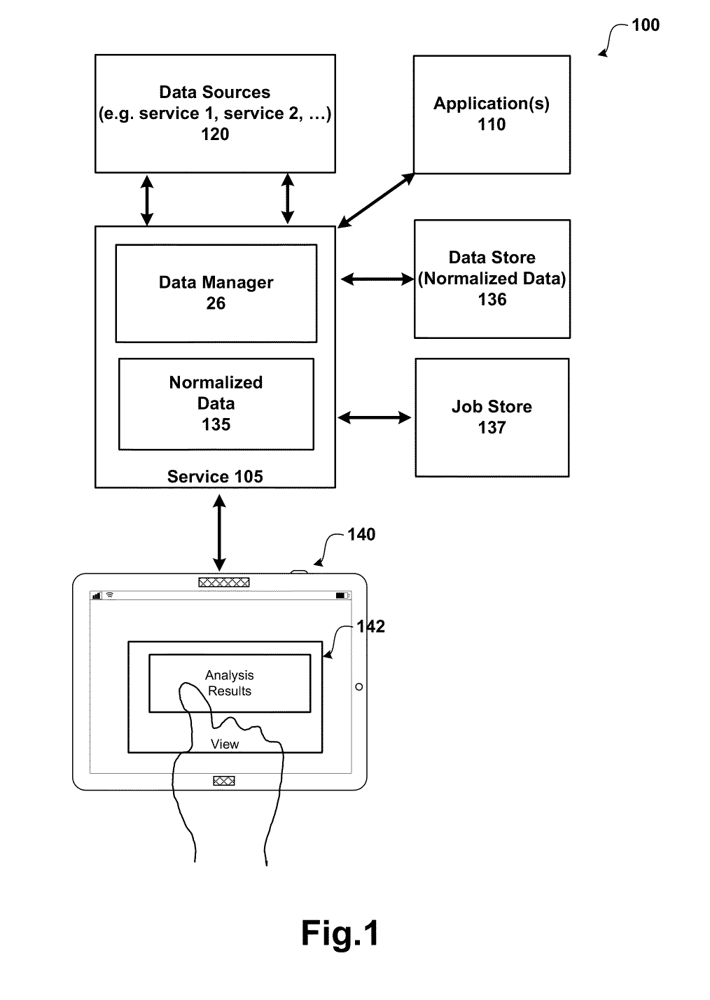

FIG. 1 shows an overview of a system for monitoring, detection and analysis of data from different services.

As illustrated, system 100 includes application(s) 110, data sources 120, service 105, normalized data 135, data store 136, data manager 26, job store 137 and computing device 140.

Data manager 26 is configured to obtain data (e.g., online service facts) from different data sources, normalize the data and analyze the data. Many times the data obtained from the different data sources is in different formats.

According to an embodiment, the normalized data is aggregated by an online (e.g. “Cloud”) service 105 and is stored by the service 105. For example, the aggregated normalized data may be stored in a data store 136 (e.g. normalized data 135). The data sources 120 from which data may be obtained may include many different types of data. For example, the data sources may include data relating to operation of an online service, operation of an application, operation of hardware, as well as other types of data. According to an embodiment, the normalized data is used for fault monitoring, detection of changes in patterns obtained from the data, as well as client defined jobs.

Data manager 26 classifies the obtained data (e.g., into error, performance and usage events/facts) based on user configured multi-dimensional (time, topology, functional area) filter criteria and/or predefined criteria.

Job store 137 is configured to store the jobs that data manager 26 performs to analyze data and provide analysis information to a client (e.g., a client associated with computing device 140). According to an embodiment, clients may submit jobs for the data they are interested in analyzing and/or viewing. Using data manager 26, service 105 obtains data from different data sources and analyzes the obtained data based on the jobs that are associated with one or more clients. For example, a client may configure a job to examine one type of data, whereas another client may configure a job to look for anomalies in the data for one or more services.

Job store 137 may also store predefined analysis that is performed by data manager 26 relating to the data. The data from the different data sources is normalized into a standard format and stored (i.e., within a data store). Data may be grouped and duplicates may be removed by data manager 26.

Analysis is performed by data manager 26 on the normalized data. For example, the analysis that is performed by data manager 26 may monitor for expected events, unexpected events, detect abnormal behavior of one or more systems, and the like. Different clients may submit different jobs to the system to obtain data from the data store. Data manager 26 may also provide a report and/or view(s) of the data to a client. For example, one or more views may be generated by data manager 26 and stored by service 105 before the view is requested from the client computing device.

As illustrated in FIG. 1, computing device 140 (e.g., a tablet) shows analysis results 142 provided by data manager 26. In order to facilitate communication with data manager 26, one or more callback routines, may be implemented. Application(s) 110 may be a variety of applications, such as PIM applications, business productivity applications, entertainment applications, music applications, travel applications, video applications, and the like. Generally, application(s) 110 may be any application that interacts with service 105. The application(s) 110 may be configured to receive different types of input (e.g. speech input, touch input, keyboard input (e.g. a physical keyboard and/or Software Input Panel (SIP)) and/or other types of input.

System 100 as illustrated comprises one or more touch screen input devices, such as tablet computing device 140, that detects when a touch input has been received (e.g. a finger touching or nearly touching the touch screen). Any type of touch screen may be utilized that detects a user's touch input. For example, the touch screen may include one or more layers of capacitive material that detects the touch input. More details are provided below.

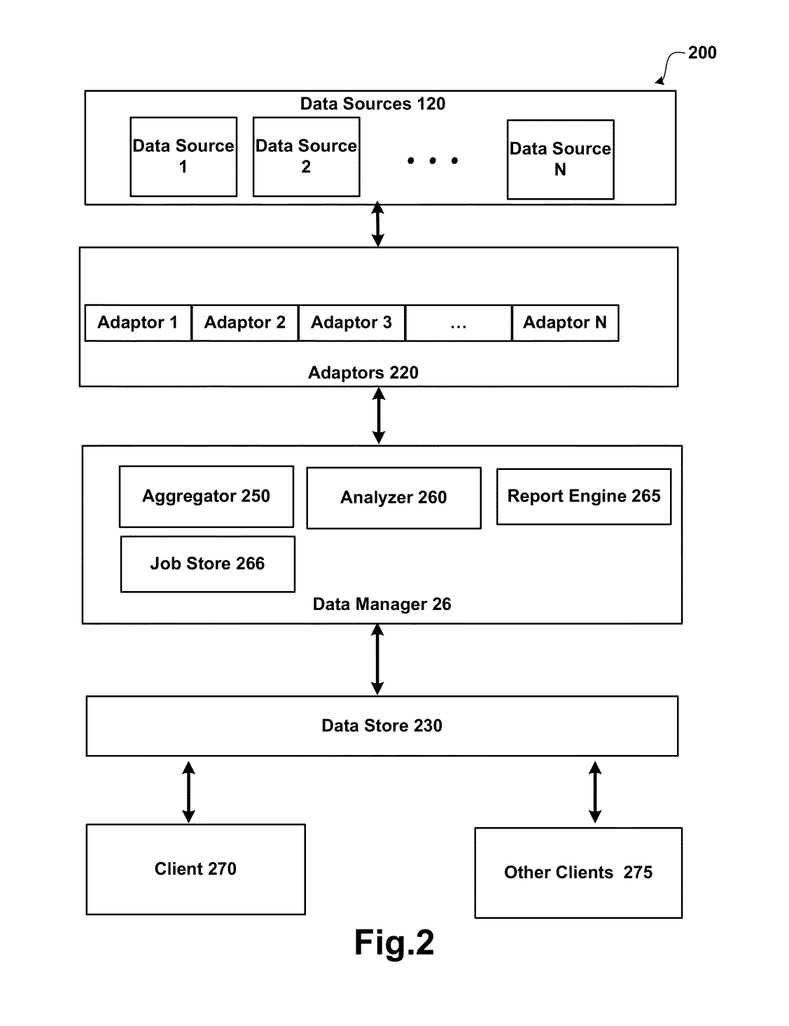

FIG. 2 illustrates a system for monitoring, detection and analysis of data from different services in different formats.

As illustrated, system 200 includes data sources 120, adaptors 220, data manager 26 (aggregator 250, analyzer 260, report engine 265, and job store 266), data store 230, client 270 and other clients 275. Instead of analyzing data from each data source individually, data manager 26 obtains and aggregates data from the data sources 120 that may be in different formats before the analysis is performed. According to an embodiment, each client uses the same methods (e.g. APIs, queries) to interact with the data once the data is normalized and stored in data store 230.

As discussed above, data sources 120 may include many different data sources. For example, data sources 120 may include data sources from: one or more online services; application sources; Personal Information Management (PIM) sources (e.g. OUTLOOK, GMAIL, YAHOO); social network sources (e.g. TWITTER, FACEBOOK, LINKEDIN . . . ), search sources (e.g. BING, GOOGLE, . . . ); and the like. Generally, a data source may be any source from which data may be obtained. According to an embodiment, the data obtained from the data sources is used to monitor the performance of an online service.

Data manager 26 uses adaptors 220 to gather data from the different data sources 120. Typically, adaptors 220 gather data from the terabytes of data produced by the different data sources 120. Data manager 26 periodically gathers the data based on user configured multi-dimensional (time, topology, functional area) filter criteria and/or predefined criteria and normalizes the data. For example, the different types or data are transformed into a unified schema format (i.e. normalized) to enable analyzer 260 to determine actionable work items (bugs/alerts/escalations) for different clients.

Adaptors 220 are configured to act an interface between data manager 26 and the different data sources 120. Different data sources may use different protocols to allow access to data in a data source. Some data sources may use their own defined protocol or may modify a common protocol. Adaptors 220 interact with each data source using the protocol that is associated with the data source being accessed. According to an embodiment, an adaptor is created to interact with each data source from which the adaptor obtains data from.

Aggregator 250 may obtain data from the data sources using adaptors 220 in response to different events. For example, aggregator 250 may obtain data periodically, in response to a notification, or in response to some other event. Aggregator 250 is configured to normalize the data that is obtained from the different data sources into a common format. According to an embodiment, the data is normalized into a unified schema for storing event information, such as but not limited to: usage event information; error event information and performance information. Aggregator 250 groups the normalized data using different variables that are associated/related to the data (e.g. type, GUIDs, date/time, user information, URLs, location, hardware type, and the like).

Each client (user) may determine what data they would like to monitor. For example, each client (e.g., client 270 and/or other clients 275) may configure what data they would like to monitor. Some data may be automatically monitored. For example, analyzer 260 may automatically detect Denial of Service (DOS) attacks, performance degradation/service availability/hardware failures through detection of anomalous patterns. Analyzer 260 may also detect a predetermined number of the most frequent changes in usage/errors/performance patterns with respect to time.

Job Store 266 stores one or more jobs that are submitted by a client. Generally, the jobs specify what data/service facts the client is interested in monitoring. Client can submit jobs of varying complexity. For example, queries may be submitted by a client that follow a common query format, a client may write code, a client may provide an executable, a client may submit rules, and the like to interact with and analyze the data. According to an embodiment, a client configures a job by specifying the details which is serialized as a base job object and stored in job store 266. The details may include all/portion of the following: a script file for fetching the data; data filters based on events/usage/errors/performance; client specified parameters; system variable parameters; job schedule, batching configuration, job output size limits, and the like.

Data store 230 contains the facts collected using adaptors 220 and stored by data manager 26. According to an embodiment, the facts are stored in a multidimensional fact store that stores facts from a relational store as an optimized multidimensional dataset. Data store may also include other data. For example, logs relating to facts of a determined importance may be stored within data store 230 and/or some other location.

Aggregator 250 removes various noise associated with the data, including removing duplicates from the data. The data, such as error messages and other data are grouped within the data store 230.

According to an embodiment, analyzer 260 automatically finds patterns based on the unified schema. Analyzer 260 may automatically report comparisons of data over parallel time periods to provide a client (e.g. client 270 and/or other clients 275). As discussed, analyzer 260 can also detect DOS attacks/performance degradation/availability/hardware failures through anomalous patterns, and the like.

Analyzer 260 may automatically/manually provide reports to clients. For example, the reports may include items, such as: comparisons of data over parallel time periods; detecting DOS attacks, performance degradation, hardware failures and the like by analyzing the normalized data for anomalous patterns. Analyzer may also detect changes in the usage, error, and performance patterns that as associated with one or more services with respect to time. According to an embodiment, analyzer 260 monitors for specified activity (e.g. errors, usage data . . . ) and records an action when a threshold is reached.

Data manager 26 is configured to expose the results of the multidimensional analysis using report engine 265. For example, a visualization may be provided to a client; a raw data set may be provided to that can be consumed by another service, a visualization engine, and/or the client. Reporting engine 265 can be configured by a client to send a time-based digest (e.g. daily electronic message) that contains the results in a form that is specified by the client.

According to an embodiment, data manager 26, using report engine 265 is configured to create view(s) of data before it is requested by a client. For example, a defined view (e.g. a performance view) of a system may be created in advance of the view being requested and/or delivered. The aggregated data may be organized into different views (e.g. across different services, per service . . . ).

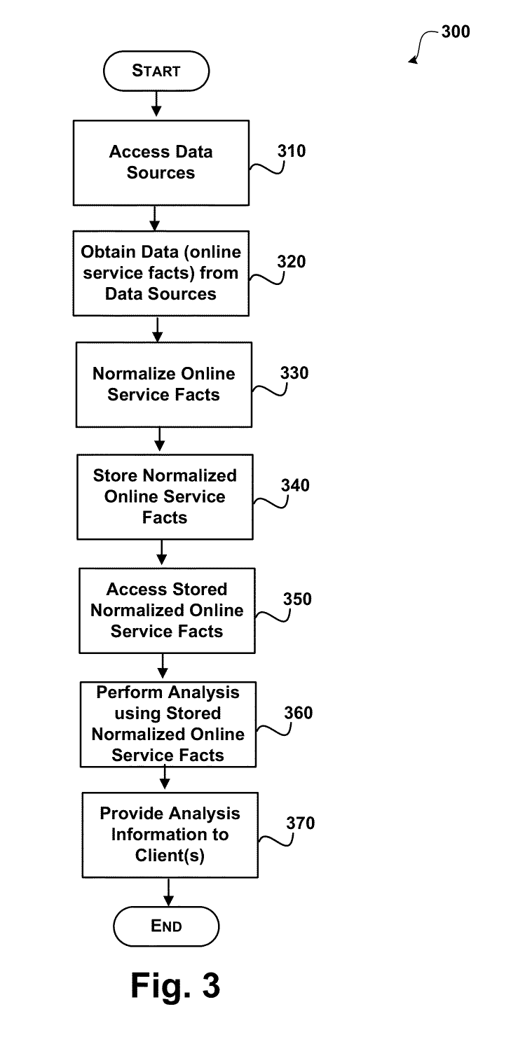

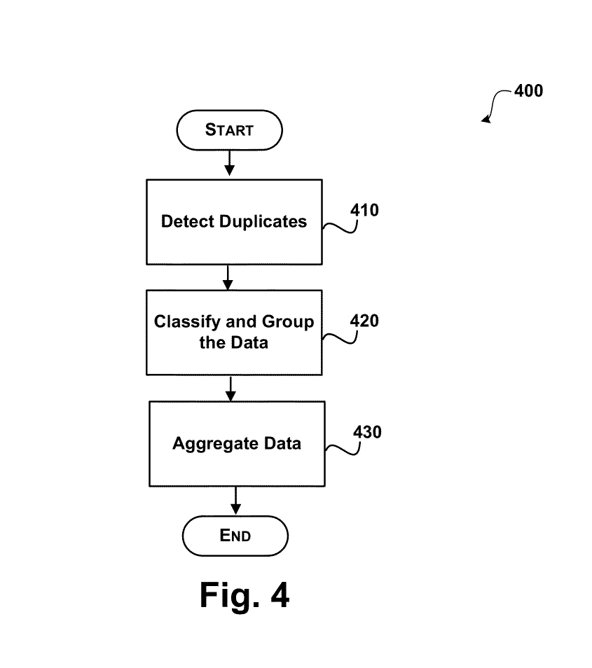

FIGS. 3 and 4 illustrate gathering data from different data sources and analyzing the data. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof. While the operations are shown in a particular order, the order of the operations may change, be performed in parallel, depending on the implementation.

FIG. 3 shows a process for accessing, obtaining, and analyzing data from different sources.

After a start operation, the process moves to operation 310, where different data sources are accessed. The data sources may be related to one or more services. Different types of data sources may be accessed. For example, one data source may provide data relating to performance of a system, another data source may relate to network connectivity, another data source may relate to interaction with a service, and the like. All or a portion of the data sources may include data that is formatted differently. For example, one data source may follow a first formatting whereas another data source may follow a second formatting.

Transitioning to operation 320, data is obtained from the data sources. According to an embodiment, an adaptor is created to interact with a data source. For example, one adaptor may be created and used to obtain data from one data source and another adaptor may be used to obtain data from a different data source. Some adaptors that are created may work with multiple data sources.

Flowing to operation 330, the obtained data is normalized. According to an embodiment, the online service facts are normalized to a standard format that is consistent across each of the different data sources. For example, each of the normalized online service facts may follow a predefined schema.

Transitioning to operation 340, the normalized data are stored. According to an embodiment, the normalized data are stored in a multidimensional database. Other storage methods may be used. Other processing may also be performed on the data (e.g., online service facts). According to an embodiment, the online service facts are grouped and duplicates are removed (See FIG. 4 and related discussion).

Moving to operation 350, the normalized data is accessed from the data store. According to an embodiment, a common Application Programming Interface (API) is used to interact with the normalized data. For example, instead of needing to access the data from each data source differently, the same method is used to access the data across the different data sources.

Flowing to operation 360, analysis is performed on the gathered and normalized data. For example, the analysis may identify important or significant facts in the system and retrieve more diagnostic logging from the data store. The analysis may compare data over different time periods and/or over parallel time periods. The analysis of the normalized data may be used to detect items, such as, but not limited to: DOS attacks; performance degradation; availability/hardware failures through anomalous patterns. The analysis may also be used to: detect changes in usage/errors/performance patterns with respect to time monitors the error/usage buckets as per the specified escalation filters and logs actionable work items per pattern; and the like.

Moving to operation 370, the analysis information is provided to the client. The analysis information may include requested data as well as automatically generated data. For example, an analysis may indicate a change in the pattern of the data that is brought to the attention of the client. The analysis information may include view(s) of the data, reports, raw data, and the like. Each different view contains the data used to render the UI for that view.

The process flows to an end operation and returns to processing other actions.

FIG. 4 shows a process for processing data that is obtained from different sources in different formats.

After a start operation, the process moves to operation 410, where any duplicates in the data are removed. According to an embodiment, the service facts that are duplicates in the obtained data are removed before storing in a multi-dimensional database.

Transitioning to operation 420, the normalized data is classified and grouped. For example, the groups may be created based on different variables in the data (e.g., Globally Unique Identifiers (GUIDs), Date/Time, Uniform Resource Locations (URLs), and the like).

Flowing to operation 430, the data is aggregated. For example, the same types of data from the same and/or different data sources are aggregated such that a more complete picture of a fact and/or pattern is provided by the data.

The process flows to an end operation and returns to processing other actions.

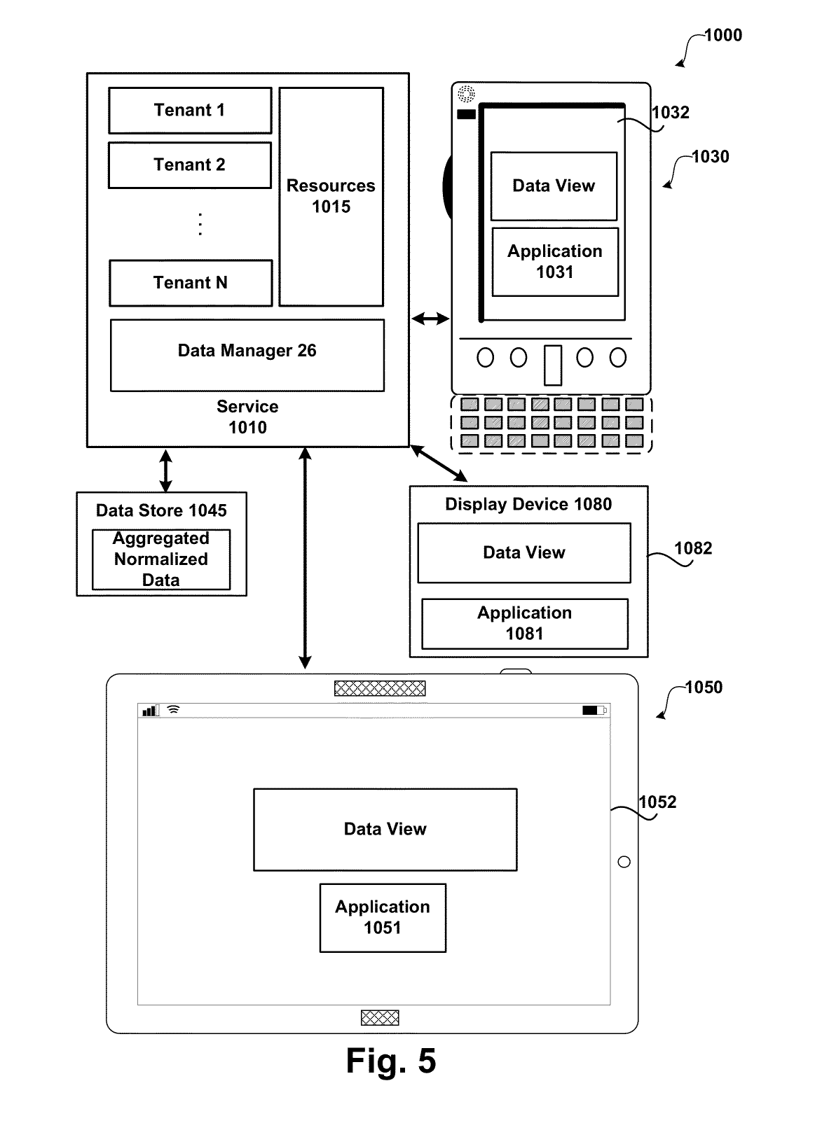

FIG. 5 illustrates an exemplary online system for gathering, and analyzing data obtained from different data sources. As illustrated, system 1000 includes service 1010, data store 1045, touch screen input device 1050 (e.g. a tablet/slate), smart phone 1030 and display device 1080.

As illustrated, service 1010 is a cloud based and/or enterprise based service that may be configured to provide services, such as analysis services. Service 1010 may be configured to provide other services. The service may be interacted with using different types of input/output. For example, a user may use speech input, touch input, hardware based input, and the like. Functionality of one or more of the services/applications provided by service 1010 may also be configured as a client/server based application.

As illustrated, service 1010 is a multi-tenant service that provides resources 1015 and services to any number of tenants (e.g. Tenants 1-N). Multi-tenant service 1010 is a cloud based service that provides resources/services 1015 to tenants subscribed to the service and maintains each tenant's data separately and protected from other tenant data.

System 1000 as illustrated comprises a touch screen input device 1050 (e.g. a slate/tablet device) and smart phone 1030 that detects when a touch input has been received (e.g. a finger touching or nearly touching the touch screen). Any type of touch screen may be utilized that detects a user's touch input. For example, the touch screen may include one or more layers of capacitive material that detects the touch input. Other sensors may be used in addition to or in place of the capacitive material. For example, Infrared (IR) sensors may be used. According to an embodiment, the touch screen is configured to detect objects that in contact with or above a touchable surface. Although the term “above” is used in this description, it should be understood that the orientation of the touch panel system is irrelevant. The term “above” is intended to be applicable to all such orientations. The touch screen may be configured to determine locations of where touch input is received (e.g. a starting point, intermediate points and an ending point). Actual contact between the touchable surface and the object may be detected by any suitable means, including, for example, by a vibration sensor or microphone coupled to the touch panel. A non-exhaustive list of examples for sensors to detect contact includes pressure-based mechanisms, micro-machined accelerometers, piezoelectric devices, capacitive sensors, resistive sensors, inductive sensors, laser vibrometers, and LED vibrometers.

According to an embodiment, smart phone 1030, touch screen input device 1050, and device 1080 are configured with applications (1031, 1051, 1081) to interact with the normalized data that is gathered and normalized by service 1010.

As illustrated, touch screen input device 1050, smart phone 1030, and display device 1080 shows exemplary displays 1052/1032/1082 showing the use of an application that receives analysis data from service 1010. Data may be stored on a device (e.g. smart phone 1030, touch screen input device 1050 and/or at some other location (e.g. network data store 1045). Data store 1045, or some other store, may be used to store aggregated data as well as other data. The applications used by the devices may be client based applications, server based applications, cloud based applications and/or some combination. According to an embodiment, display device 1080 is a device such as a MICROSOFT XBOX coupled to a display.

Data manager 26 is configured to perform operations relating to gathering and analyzing data as described herein. While manager 26 is shown within service 1010, the functionality of the manager may be included in other locations (e.g. on smart phone 1030 and/or touch screen input device 1050 and/or device 1080).

The embodiments and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, the embodiments and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

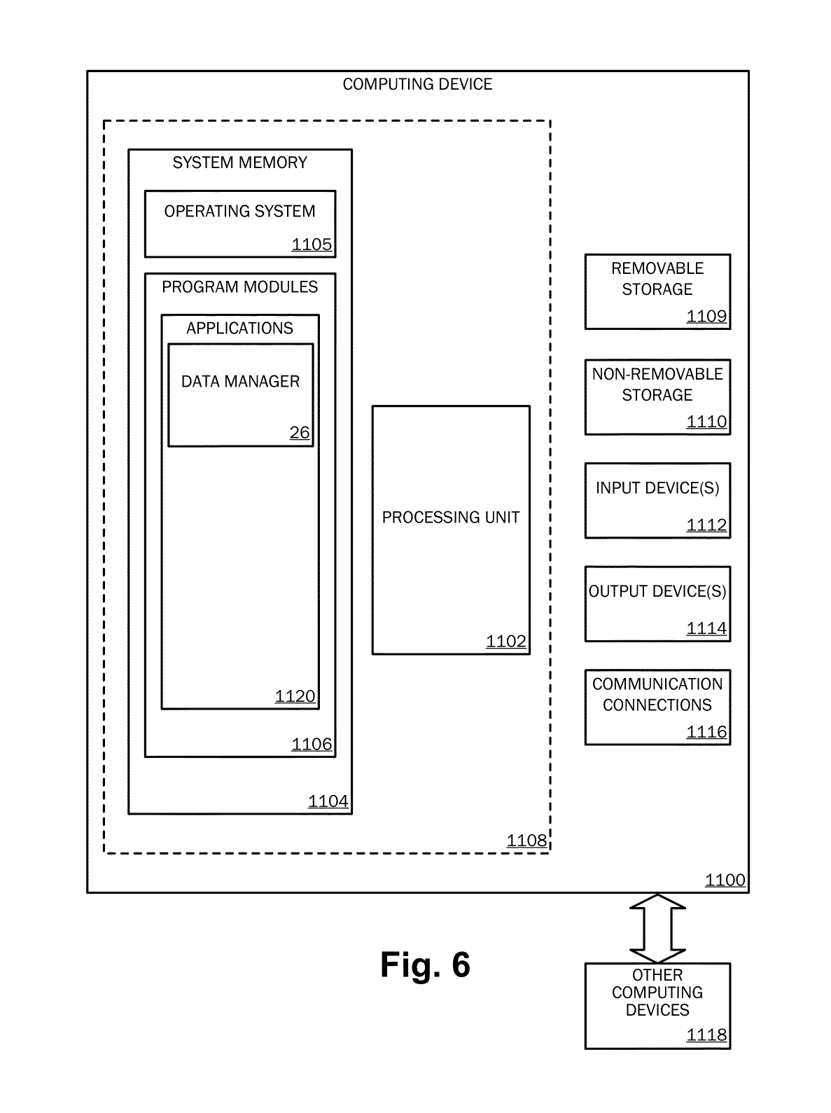

FIGS. 6-8 and the associated descriptions provide a discussion of a variety of operating environments in which embodiments of the invention may be practiced. However, the devices and systems illustrated and discussed with respect to FIGS. 6-8 are for purposes of example and illustration and are not limiting of a vast number of computing device configurations that may be utilized for practicing embodiments of the invention, described herein.

FIG. 6 is a block diagram illustrating physical components (i.e., hardware) of a computing device 1100 with which embodiments of the invention may be practiced. The computing device components described below may be suitable for the computing devices described above. In a basic configuration, the computing device 1100 may include at least one processing unit 1102 and a system memory 1104. Depending on the configuration and type of computing device, the system memory 1104 may comprise, but is not limited to, volatile storage (e.g., random access memory), non-volatile storage (e.g., read-only memory), flash memory, or any combination of such memories. The system memory 1104 may include an operating system 1105 and one or more program modules 1106 suitable for running software applications 1120 such as the data manager 26. The operating system 1105, for example, may be suitable for controlling the operation of the computing device 1100. Furthermore, embodiments of the invention may be practiced in conjunction with a graphics library, other operating systems, or any other application program and is not limited to any particular application or system. This basic configuration is illustrated in FIG. 6 by those components within a dashed line 1108. The computing device 1100 may have additional features or functionality. For example, the computing device 1100 may also include additional data storage devices (removable and/or non-removable) such as, for example, magnetic disks, optical disks, or tape. Such additional storage is illustrated in FIG. 6 by a removable storage device 1109 and a non-removable storage device 1110.

As stated above, a number of program modules and data files may be stored in the system memory 1104. While executing on the processing unit 1102, the program modules 1106 (e.g., the data manager 26) may perform processes including, but not limited to, one or more of the stages of the methods and processes illustrated in the figures. Other program modules that may be used in accordance with embodiments of the present invention may include electronic mail and contacts applications, word processing applications, spreadsheet applications, database applications, slide presentation applications, drawing or computer-aided application programs, etc.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the data manager 26 may be operated via application-specific logic integrated with other components of the computing device 1100 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

The computing device 1100 may also have one or more input device(s) 1112 such as a keyboard, a mouse, a pen, a sound input device, a touch input device, etc. The output device(s) 1114 such as a display, speakers, a printer, etc. may also be included. The aforementioned devices are examples and others may be used. The computing device 1100 may include one or more communication connections 1116 allowing communications with other computing devices 1118. Examples of suitable communication connections 1116 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 1104, the removable storage device 1109, and the non-removable storage device 1110 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1100. Any such computer storage media may be part of the computing device 1100. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

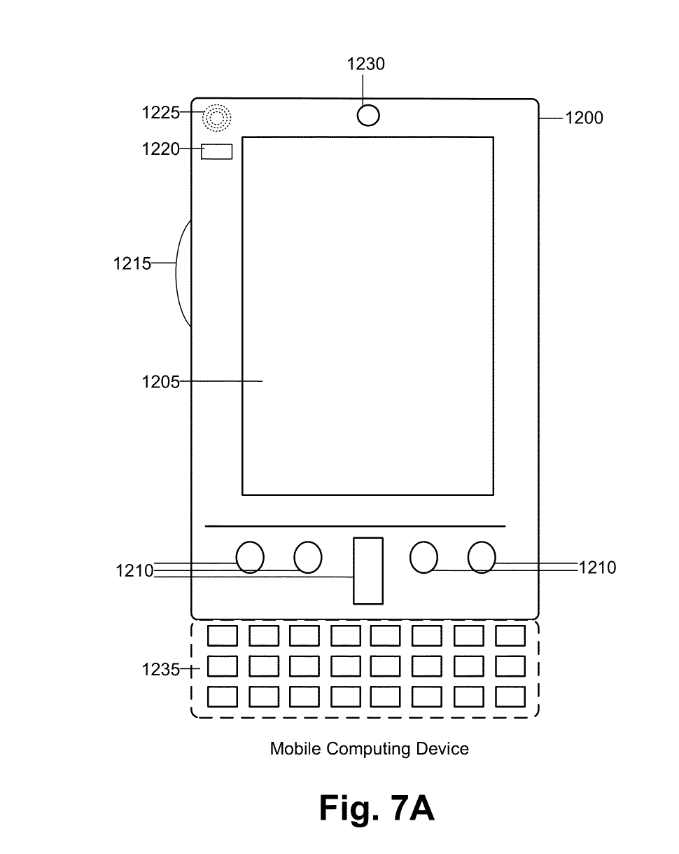

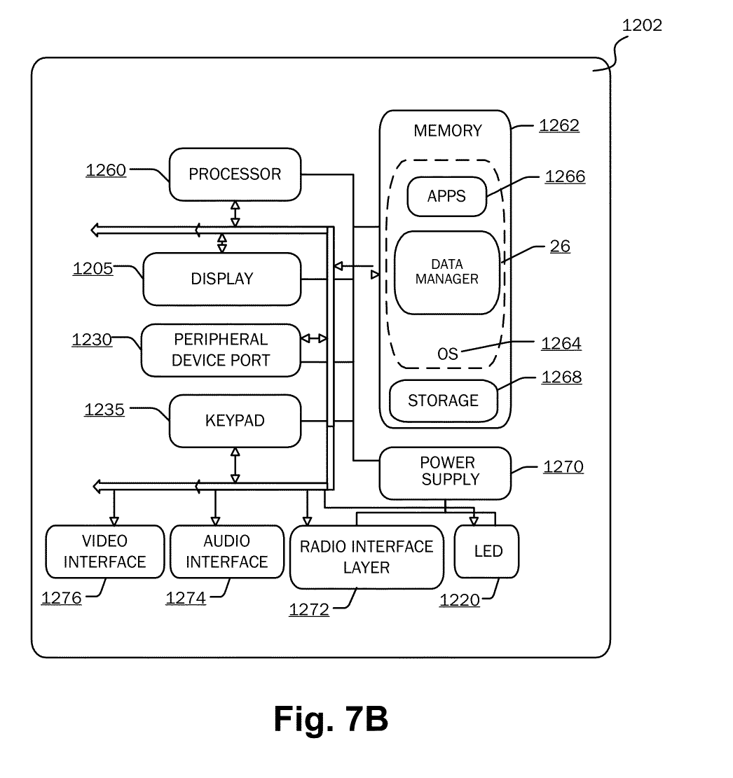

FIGS. 7A and 7B illustrate a mobile computing device 1200, for example, a mobile telephone, a smart phone, a tablet personal computer, a laptop computer, and the like, with which embodiments of the invention may be practiced. With reference to FIG. 7A, one embodiment of a mobile computing device 1200 for implementing the embodiments is illustrated. In a basic configuration, the mobile computing device 1200 is a handheld computer having both input elements and output elements. The mobile computing device 1200 typically includes a display 1205 and one or more input buttons 1210 that allow the user to enter information into the mobile computing device 1200. The display 1205 of the mobile computing device 1200 may also function as an input device (e.g., a touch screen display). If included, an optional side input element 1215 allows further user input. The side input element 1215 may be a rotary switch, a button, or any other type of manual input element. In alternative embodiments, mobile computing device 1200 may incorporate more or less input elements. For example, the display 1205 may not be a touch screen in some embodiments. In yet another alternative embodiment, the mobile computing device 1200 is a portable phone system, such as a cellular phone. The mobile computing device 1200 may also include an optional keypad 1235. Optional keypad 1235 may be a physical keypad or a “soft” keypad generated on the touch screen display. In various embodiments, the output elements include the display 1205 for showing a graphical user interface (GUI), a visual indicator 1220 (e.g., a light emitting diode), and/or an audio transducer 1225 (e.g., a speaker). In some embodiments, the mobile computing device 1200 incorporates a vibration transducer for providing the user with tactile feedback. In yet another embodiment, the mobile computing device 1200 incorporates input and/or output ports, such as an audio input (e.g., a microphone jack), an audio output (e.g., a headphone jack), and a video output (e.g., a HDMI port) for sending signals to or receiving signals from an external device.

FIG. 7B is a block diagram illustrating the architecture of one embodiment of a mobile computing device. That is, the mobile computing device 1200 can incorporate a system 1202 (i.e., an architecture) to implement some embodiments. In one embodiment, the system 1202 is implemented as a “smart phone” capable of running one or more applications (e.g., browser, e-mail, calendaring, contact managers, messaging clients, games, and media clients/players). In some embodiments, the system 1202 is integrated as a computing device, such as an integrated personal digital assistant (PDA) and wireless phone.

One or more application programs 1266 may be loaded into the memory 1262 and run on or in association with the operating system 1264. Examples of the application programs include phone dialer programs, e-mail programs, personal information management (PIM) programs, word processing programs, spreadsheet programs, Internet browser programs, messaging programs, and so forth. The system 1202 also includes a non-volatile storage area 1268 within the memory 1262. The non-volatile storage area 1268 may be used to store persistent information that should not be lost if the system 1202 is powered down. The application programs 1266 may use and store information in the non-volatile storage area 1268, such as e-mail or other messages used by an e-mail application, and the like. A synchronization application (not shown) also resides on the system 1202 and is programmed to interact with a corresponding synchronization application resident on a host computer to keep the information stored in the non-volatile storage area 1268 synchronized with corresponding information stored at the host computer. As should be appreciated, other applications may be loaded into the memory 1262 and run on the mobile computing device 1200, including the data manager 26 as described herein.

The system 1202 has a power supply 1270, which may be implemented as one or more batteries. The power supply 1270 might further include an external power source, such as an AC adapter or a powered docking cradle that supplements or recharges the batteries.

The system 1202 may also include a radio 1272 that performs the function of transmitting and receiving radio frequency communications. The radio 1272 facilitates wireless connectivity between the system 1202 and the “outside world,” via a communications carrier or service provider. Transmissions to and from the radio 1272 are conducted under control of the operating system 1264. In other words, communications received by the radio 1272 may be disseminated to the application programs 1266 via the operating system 1264, and vice versa.

The visual indicator 1220 may be used to provide visual notifications, and/or an audio interface 1274 may be used for producing audible notifications via the audio transducer 1225. In the illustrated embodiment, the visual indicator 1220 is a light emitting diode (LED) and the audio transducer 1225 is a speaker. These devices may be directly coupled to the power supply 1270 so that when activated, they remain on for a duration dictated by the notification mechanism even though the processor 1260 and other components might shut down for conserving battery power. The LED may be programmed to remain on indefinitely until the user takes action to indicate the powered-on status of the device. The audio interface 1274 is used to provide audible signals to and receive audible signals from the user. For example, in addition to being coupled to the audio transducer 1225, the audio interface 1274 may also be coupled to a microphone to receive audible input, such as to facilitate a telephone conversation. In accordance with embodiments of the present invention, the microphone may also serve as an audio sensor to facilitate control of notifications, as will be described below. The system 1202 may further include a video interface 1276 that enables an operation of an on-board camera to record still images, video stream, and the like.

A mobile computing device 1200 implementing the system 1202 may have additional features or functionality. For example, the mobile computing device 1200 may also include additional data storage devices (removable and/or non-removable) such as, magnetic disks, optical disks, or tape. Such additional storage is illustrated in FIG. 7B by the non-volatile storage area 1268. Mobile computing device 1200 may also include peripheral device port 1230.

Data/information generated or captured by the mobile computing device 1200 and stored via the system 1202 may be stored locally on the mobile computing device 1200, as described above, or the data may be stored on any number of storage media that may be accessed by the device via the radio 1272 or via a wired connection between the mobile computing device 1200 and a separate computing device associated with the mobile computing device 1200, for example, a server computer in a distributed computing network, such as the Internet. As should be appreciated such data/information may be accessed via the mobile computing device 1200 via the radio 1272 or via a distributed computing network. Similarly, such data/information may be readily transferred between computing devices for storage and use according to well-known data/information transfer and storage means, including electronic mail and collaborative data/information sharing systems.

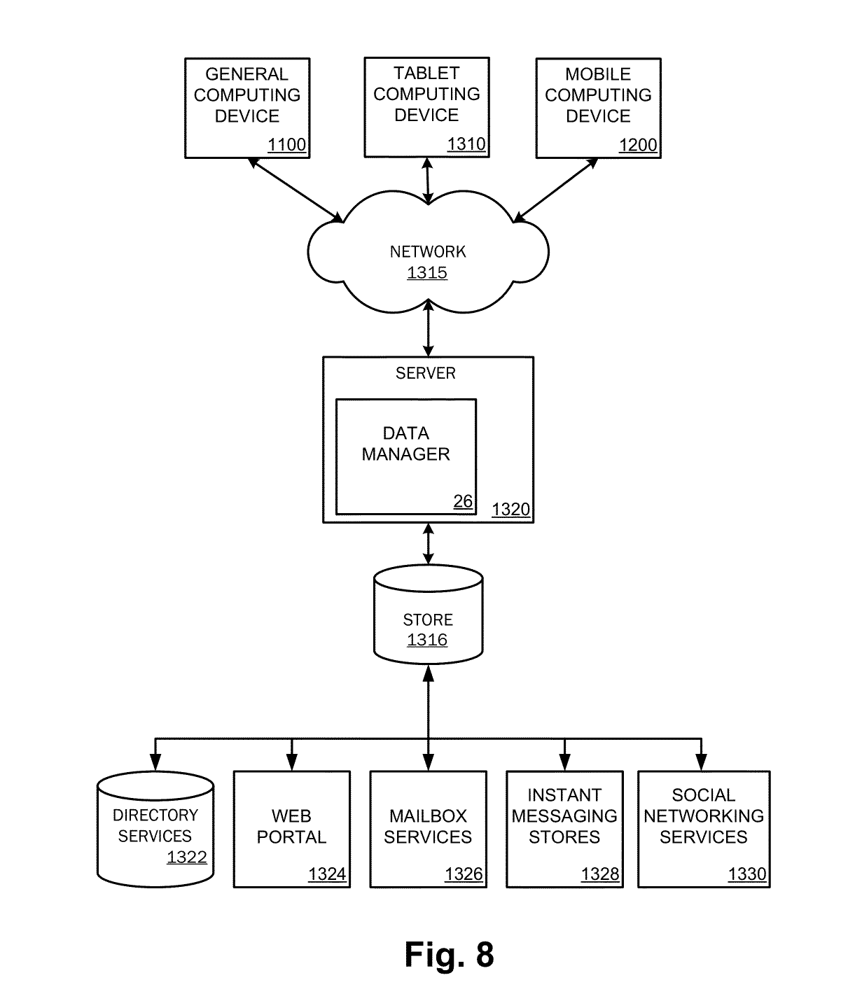

FIG. 8 illustrates an embodiment of an architecture of an exemplary system, as described above. Data developed, interacted with, or edited in association with the data manager 26 may be stored in different communication channels or other storage types. For example, various documents may be stored using a directory service 1322, a web portal 1324, a mailbox service 1326, an instant messaging store 1328, or a social networking site 1330. The data manager 26 may use any of these types of systems or the like for enabling data utilization, as described herein. A server 1320 may provide the data manager 26 to clients. As one example, the server 1320 may be a web server providing the data manager 26 over the web. The server 1320 may provide the data manager 26 over the web to clients through a network 1315. By way of example, the client computing device may be implemented as the computing device 1100 and embodied in a personal computer, a tablet computing device 1310 and/or a mobile computing device 1200 (e.g., a smart phone). Any of these embodiments of the client computing device 1100, 1310, and 1200 may obtain data from the store 1316.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

What is claimed is:

1. A method for collecting and analyzing data from different data sources, comprising:
obtaining data comprising online service facts in different formats from different data sources;
normalizing the online service facts obtained in the different formats from the different data sources;
storing the normalized online service facts;
accessing the normalized online service facts; and
analyzing the normalized online service facts.

2. The method of claim 1, further comprising receiving a query to determine the normalized online service facts to access.

3. The method of claim 1, wherein analyzing the normalized online service facts comprises detecting abnormal behavior of a system based on an automated analysis of at least a portion of the normalized online service facts.

4. The method of claim 1, wherein analyzing the normalized online service facts comprises monitoring for expected events of a system and unexpected events of the system.

5. The method of claim 1, wherein storing the normalized online service facts comprises storing the normalized online service facts in a multi-dimensional data store.

6. The method of claim 1, further comprising providing a visualization of a portion of the normalized online service facts obtained from the different data sources.

7. The method of claim 1, further comprising storing queries from different users that are periodically performed against the stored online service facts.

8. The method of claim 1, further comprising grouping the normalized online service facts.

9. The method of claim 1, further comprising determining duplicates from the normalized online service facts obtained from the different data sources and removing the determined duplicates from the normalized online service facts.

10. The method of claim 1, further comprising storing jobs from different users that specify online service facts to analyze.

11. A computer-readable medium storing computer-executable instructions for collecting and analyzing data from different data sources, comprising:
periodically obtaining data comprising online service facts in different formats from different data sources;
normalizing the online service facts obtained in the different formats from the different data sources;
removing duplicate online service facts from the obtained online service facts;
storing the normalized online service facts in a multi-dimensional data store;
accessing the normalized online service facts; and
analyzing the normalized online service facts.

12. The computer-readable medium of claim 11, further comprising analyzing the normalized online service facts based on a job submitted by a client.

13. The computer-readable medium of claim 11, wherein analyzing the normalized online service facts comprises at least one of: detecting abnormal behavior of a system based on at least a portion of the normalized online service facts or monitoring for expected events of a system and unexpected events of the system.

14. The computer-readable medium of claim 11, further comprising providing a visualization of a portion of the normalized online service facts obtained from the different data sources.

15. The computer-readable medium of claim 11, further comprising grouping the normalized online service facts.

16. The computer-readable medium of claim 11, wherein analyzing the normalized online service facts comprises automatically detecting performance degradation and Denial of Service attacks.

17. A system for collecting and analyzing data from different data sources, comprising:
a processor and memory;
an operating environment executing using the processor; and
an data manager that is configured to perform actions comprising:
periodically obtaining data comprising online service facts in different formats from different data sources;
normalizing the online service facts obtained in the different formats from the different data sources;
removing duplicate online service facts from the obtained online service facts;
grouping the normalized online service facts
storing the normalized online service facts in a multi-dimensional data store;
accessing the normalized online service facts; and
analyzing the normalized online service facts.

18. The system of claim 17, further comprising analyzing the normalized online service facts based on jobs submitted by different clients.

19. The system of claim 17, wherein analyzing the normalized online service facts comprises at least one of: detecting abnormal behavior of a system based on at least a portion of the normalized online service facts or monitoring for expected events of a system and unexpected events of the system.

20. The system of claim 17, further comprising providing a visualization of a portion of the normalized online service facts obtained from the different data sources.
